(19) United States
(12) Patent Application Publication
(10) Pub. No.: US 2001/0001893 A1
(43) Pub. Date: May 31, 2001

(54) METHOD AND APPARATUS FOR MANUFACTURING MOLD

(76) Inventor: KOHICHI MATSUURA, YOKOHAMA-SHI (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 08/757,235

(22) Filed: Nov. 27, 1996

(30) Foreign Application Priority Data
Nov. 29, 1995 (JP) 333921/1995

(51) Int. Cl. B23C 1/00; B23P 13/00

(52) U.S. Cl. 29/557; 409/137

(57) ABSTRACT

There are disclosed a method and apparatus for manufacturing a mold for casting a large-size product having a complex shape. The method for manufacturing a mold includes the steps of preparing a block in which powder granular material is cured, and processing the block by an automatic processing machine to define a molding surface in the block according to a pre-installed program.

### BACKGROUND OF THE INVENTION

1. Field of the Invention

The present invention relates to a method and apparatus for manufacturing a mold for casting a metal product, more particularly to a method and apparatus for manufacturing a mold without using a prototype model to be produced.

2. Description of the Related Art

The conventional process for manufacturing a cast metal product having a complex shape includes a step of preparing a prototype model (core mold) having the same shape as the product to be produced and a step of manufacturing a mold using the prototype model. The prototype model, which may be made of wood, metal or resin, is usually made by using a precision processing machine because of its complex shape and requirement for a high degree dimensional accuracy. Then the mold (cavity mold) for casting the products is manufactured by transferring the shape of the prototype model to a sand mold, and then, solidifying the sand mold.

After the shape of the prototype model is transferred to the sand mold, the prototype model is removed from the sand mold. The sand model is removed from the prototype model by dividing it into a few pieces when the sand mold is made dividable, or, by heating it to burn or melt after providing the sand mold material around the prototype model when the prototype model is made of wax or resin.

In the above method, steps of manufacturing the prototype model and transferring the shape of the prototype model to the sand mold are necessary, which make the entire process complicated, and a reproducibility of the shape is relatively low. Particularly, when the prototype model is relatively large as well as of a complex shape, the prototype model made of wax or resin does not have a sufficient mechanical strength to deteriorate operational convenience and dimensional accuracy. When the sand mold is made dividable, it is very difficult to remove the sand mold by dividing because its weight and dimension is large and may possibly cause chipping of details.

### SUMMARY OF THE INVENTION

It is therefore an object of the present invention to provide a method and apparatus for manufacturing a mold suitable for molding a large-size product having a complex shape, which makes the use of a prototype model of the cast product unnecessary, thereby reducing the necessary steps compared to the conventional method, and in which a high level of reproducibility of the shape can be achieved.

According to a first aspect of the present invention, a method for manufacturing a mold comprises the steps of: preparing a block made of a solidified powder granular material; and directly processing the block by an automatic processing machine to form a molding surface on the block, said automatic processing machine comprising a control section for controlling a machining tool in accordance with a pre-installed program.

According to a second aspect of the present invention, an apparatus for manufacturing a mold comprises a processing table on which a block to be processed is placed, an automatic processing machine to process the block according to a pre-installed program, and an absorption pipe for absorbing powder particles generated during the processing, the absorption pipe having an opening provided adjacent a processed portion of the block.

According to the present invention, since the mold is directly produced by processing a sand block, a detailed and complicated shape can be processed on the block, and the conventional shape transferring step is not required. Therefore, the mold produced by the present invention makes it possible to conduct a more precise molding process. Consequently, a product having a complicated shape can be cast with a high level of reproducibility and less cost.

The above and other objects, features, and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1A is a schematic illustration showing an outline of the present invention;

FIG. 1B is a perspective view showing an apparatus for manufacturing a mold of the present invention;

FIG. 2A is a perspective view showing a sand block before being processed;

FIG. 2B is a perspective view showing a lower mold;

FIG. 2C is a perspective view showing an upper mold; and

FIG. 2D is a perspective view showing a mold in which the lower mold and the upper mold are combined.

### DETAILED DESCRIPTION OF THE PREFERRED EMBODIMENT

Hereinafter, a preferred embodiment of the present invention will now be described in detail, referring to the drawings.

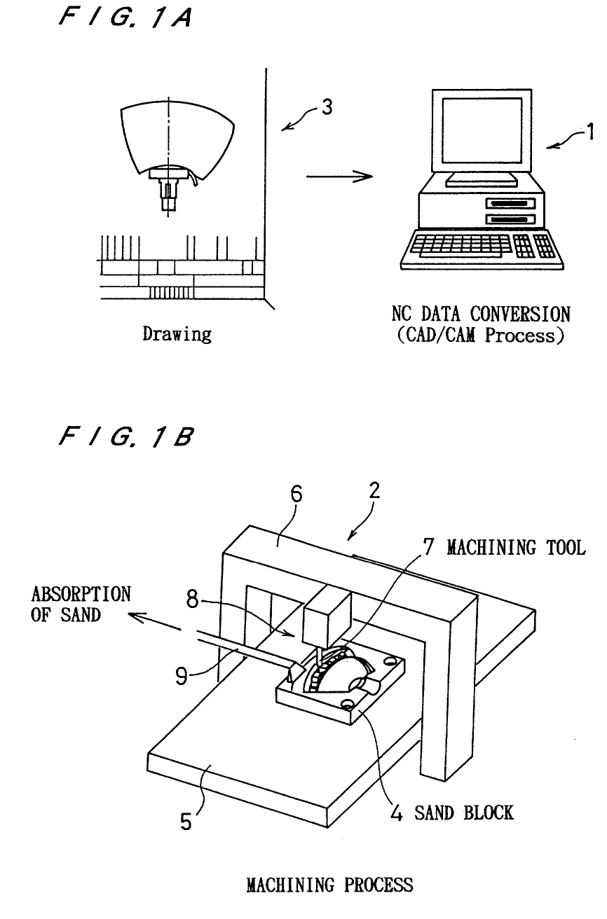

FIG. 1A is a schematic illustration showing an outline of a method and apparatus of manufacturing a mold of the present invention. FIG. 1A shows a data inputting process where data regarding a three-dimensional shape and size of the mold is inputted in a computer 1, and an automatic processing machine 2 controls its machine head provided with a machining tool in accordance with the inputted data and then processes the mold. This input process is carried out by a widely-used program, namely, Computer Aided Manufacturing (CAM). The data regarding the shape and size of the mold may be inputted by an operator or by using various devices or programs which has been developed and capable of directly or indirectly reading the data from a drawing of a model 3 or a model itself.

The mold is designed in consideration of various factors such as solidification shrinkage or cutting stock for finish in addition to the design of the product cast by the mold. When the design of the mold is conducted by using a program, namely, Computer Aided Design (CAD) with display of an image of the mold, the data of the CAD may be directly used as the data of the CAM. In this case, the step for inputting the data to CAM can be omitted. Also, when the product to be manufactured by casting itself is designed by using the CAD, the mold can be automatically designed at the same time, which can further shorten the time necessary for manufacturing the mold.

FIG. 1B is a perspective view showing an automatic processing machine 2 according to the present invention. The automatic processing machine 2 has a processing table 5 on which a sand block 4 to be processed is placed. Above the processing table 5, a tool support portion 6 is provided to bridge over the processing table 5. The tool support portion 6 is provided with a machine head 8 movable in one or a few directions for supporting and driving a machining tool 7 such as a drill, an end mill or a milling cutter. The automatic processing machine 2 is also provided with a control device for controlling the movement of the machine head 8 and the rotation of the machining tool 7. The automatic processing machine 2 has one or more absorption pipes 9 connected to a vacuum pump (not shown) for absorbing and exhausting sand or dust generated due to the processing of the block 4. The absorption pipe 9 may be preferably provided on the machine head 8 so as to move together so that the opening end of the absorption pipe 9 is always set close to the machining tool 7 processing the block 4, thus, securely exhausting the sand or dust.

The mold may be produced by the above automatic processing machine in the following manner. In this example, two plate-like blocks 4 are prepared, and each of the confronting faces are processed into a molding surface. The blocks 4 are then combined to build up a mold comprising a lower mold 4a and an upper mold 4b. The material for the block 4 is required to have, in addition to the usual properties required as a mold material, certain mechanical workability enough for preventing the occurrence of chipping during processing, though a strict specification is not necessary. According to the experimental tests held by the inventors, blocks 4 having a compressive strength larger than 20 kg/cm² did not induce any problems. However, when the compressive strength of the block 4 was larger than 80 kg/cm², the processing efficiency or the life of the tools 7 was lowered. Thus, the optimum range of the compressive strength of the block 4 is 40-60 kg/cm².

The sand material of the block 4 is preferably prepared to be finer than usual, when the processing efficiency and the life of the tools 7 is taken into consideration. When the mold is used for casting a product having a high crack sensitivity, a block made of a special sand material should be used. A mold generally called as a CO₂ mold including water glass as a bond which is cured by gas, or a furan resin mold in which furan resin is cured by acid contained therein may preferably be used.

At the corners of the confronting surfaces of the blocks 4, there are formed recesses 10a and projections 10b for positioning the blocks 4 to each other. The recesses 10a and the projections 10b may be formed at the time when the block 4 was manufactured or simultaneously when the molding surface is processed on the block 4 by the automatic processing machine 2. The projections 10b can be also formed by preparing in advance a projection element having a shape in which two truncated corns are connected at their bottoms, and inserting the object into the recess 10a formed in the block 4. In this case, the entire surface of the block 4 does not have to be ground just because forming of the projections 10b is necessary.

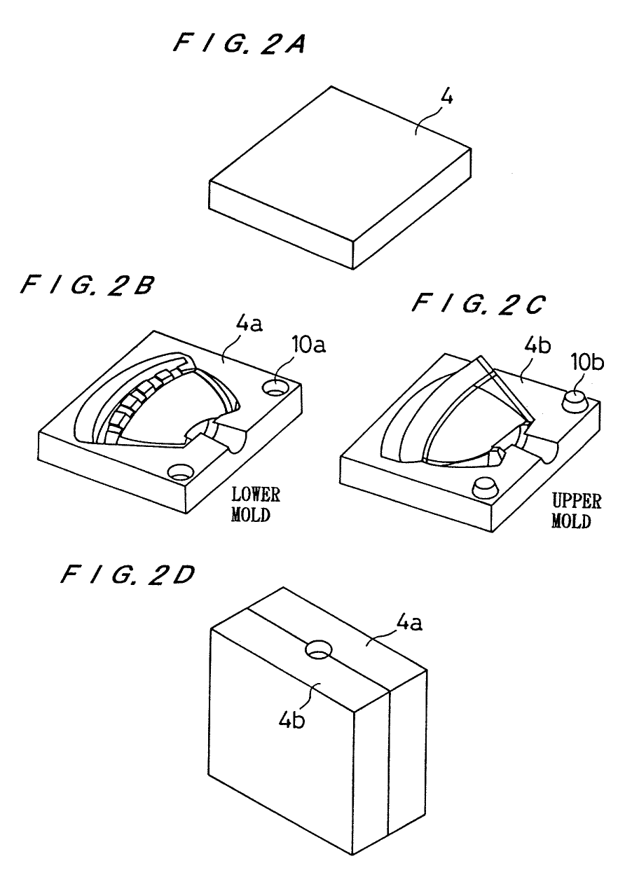

The processing of the surface of the block 4, which is placed on and positioned to the processing table 5, is carried out by the automatic processing machine 2 according to the program which was installed in advance. The automatic processing machine 2 may have a mechanism for automatically changing the machining tools 7 required in the processing. When such a mechanism is not provided in the automatic processing machine 2, the tools 7 are changed in order by an operator. After the mechanical processing for forming a cavity including a sprue for casting a metal, a surface treatment is conducted on the processed surface to strength the surface when it is necessary. Through the above process, the blocks 4 are processed into a lower mold 4a and an upper mold 4b shown in FIGS. 2B and 2C, respectively. The lower mold 4a and the upper mold 4b are integrated to produce a mold by adhering or fastening after matching their molding surfaces by using the recesses 10a and projections 10b as positioning means. In this example, the molding surface of the upper mold 4b is protruded from its matching surface.

According to the method and apparatus for manufacturing a mold of the present invention, the processing is conducted while absorbing the sand chips by the absorption pipe 9 opening close to the block 4, which prevents the sand from entering into a space between the tool 7 and block 4 during the processing and damaging the processed surface. Also, since the absorption pipe 9 absorbs the sand dust during the processing, the operational environment is kept in good condition.

In the present invention, since the block 4 can be processed based on the data regarding the shape and size of the mold or the cast product inputted in a computer, it is usable for mass production system for the cast product, nevertheless, it is also suitable for a multi-product small quantity production. Also, since the data can easily be amended or combined by utilizing the CAD method, it is easy to incorporate molding conditions or to respond to minor changes of a design.

Although a certain preferred embodiment of the present invention has been shown and described in detail, it should be understood that various changes and modifications may be made therein without departing from the scope of the appended claims.

What is claimed is:

1. A method for manufacturing a mold comprising the steps of:
preparing a block made of a solidified powder granular material; and
directly processing said block by an automatic processing machine to form a molding surface on said block, said automatic processing machine comprising a control section for controlling a machining tool in accordance with a pre-installed program.

2. A method for manufacturing a mold according to claim 1, further comprising the step of obtaining data for processing said block based on a dimensional data of a product to be cast.

3. A method for manufacturing a mold according to claim 1, further comprising the step of combining a plurality of said blocks.

4. A method for manufacturing a mold according to claim 3, further comprising the step of providing a projection and a recess on matching surfaces of said blocks for relatively positioning the blocks to each other.

5. A method for manufacturing a mold according to claim 3, further comprising the steps of:
providing a recess on each matching surface of said blocks: and
inserting a positioning element into said recess for relatively positioning the blocks to each other.

6. A method for manufacturing a mold according to claim 3, wherein said plurality of blocks are formed in a plate-like shape.

7. A method for manufacturing a mold according to claim 1, wherein said block is prepared by solidifying said powder granular material at a compressive strength ranging from 20 to 80 kg/cm².

8. An apparatus for manufacturing a mold comprising:
a processing table on which a block to be processed is placed;
an automatic processing machine to process said block according to a pre-installed program; and
an absorption pipe for absorbing powder particles generated during the processing, said absorption pipe having an opening provided adjacent a processed portion of said block.
